(19) United States
(12) Patent Application Publication
(10) Pub. No.: US 2012/0188282 A1
(43) Pub. Date: Jul. 26, 2012

(54) METHOD FOR ADJUSTING IMAGE DISPLAYED ON SCREEN OF ELECTRONIC DEVICE

(75) Inventor: JUN LI, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/097,060

(22) Filed: Apr. 29, 2011

(30) Foreign Application Priority Data
Jan. 25, 2011 (CN) 201110026891.4

(51) Int. Cl. G09G 5/00

(52) U.S. Cl. 345/649

(57) ABSTRACT

A method for adjusting an image displayed on a screen of an electronic device uses an accelerometer of the electronic device to measure a rotation angle and a rotation direction of the electronic device when the electronic device is rotated. The electronic device acquires the rotation angle and the rotation direction from the accelerometer and reversely rotates the image relative to the rotation direction by the rotation angle.

### BACKGROUND

1. Technical Field

The present disclosure relates to a method for adjusting an image displayed on a screen of an electronic device.

2. Description of Related Art

Many electronic devices, such as a phone, include an accelerometer for specific application programs. For example, a racing game can be operated based on a rotation angle and a rotation direction of the electronic device, which is measured by the accelerometer. A user may rotate the electronic device clockwise or counterclockwise relative to the screen of the electronic device when playing the racing game, to control the car of the racing game displayed on the screen to turn right or left correspondingly. However, the image of the racing game will be tilted when the electronic device is rotated.

### BRIEF DESCRIPTION OF THE DRAWINGS

FIG. 1 is a block diagram of one exemplary embodiment of an electronic device.

FIG. 2 is one example of a game image displayed on a screen shown in FIG. 1.

FIG. 3 is one example of the game image shown in FIG. 2 without adjustment during operation.

FIG. 4 is one example of the game image shown in FIG. 2 with adjustment during operation.

FIG. 5 is a flowchart illustrating one exemplary embodiment of a method for adjusting an image displayed on a screen of an electronic device.

### DETAILED DESCRIPTION

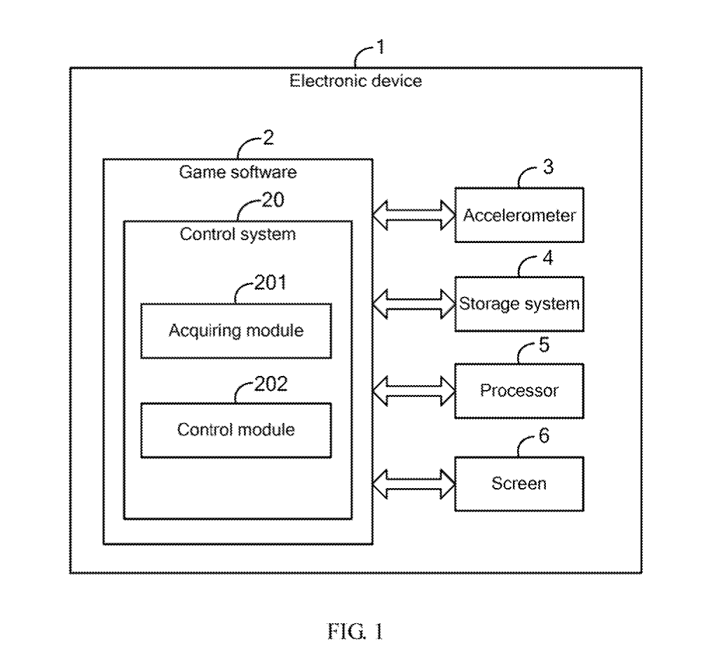

FIG. 1 is a block diagram of one exemplary embodiment of an electronic device 1. The electronic device 1 may be a mobile phone, a tablet PC, or a personal digital assistant, for example. The electronic device 1 includes game software 2, an accelerometer 3, a storage system 4, a processor 5, and a screen 6. The game software 2 includes a control system 20. The accelerometer 3 may measure a rotation angle and a rotation direction of the electronic device 1 when the electronic device is rotated. A rotation axis of the rotation direction is perpendicular to the screen. The screen 6 may display images.

In general, the word “module” as used herein, refers to logic embodied in hardware or firmware, or to a collection of software instructions, written in a programming language, such as, for example, Java, C, or Assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as software and/or a hardware unit and may be stored in any type of computer-readable medium or other computer storage device.

The control system 20 includes an acquiring module 201 and a control module 202. The modules 201-202 may comprise computerized code in the form of one or more programs that are stored in the control system 20. The computerized code includes instructions that are executed by the processor 5 to provide functions for the modules 201-202. The acquiring module 201 acquires the rotation angle and the rotation direction from the accelerometer 3. The control module 202 reversely rotates the image relative to the rotation direction by the rotation angle. It should be understood that “reversely rotates” is defined as an action of an object that is rotated in the opposite direction from a first position. For example, when the electronic device 1 is rotated counterclockwise by the rotation angle, the control module 202 can rotate the image clockwise by the rotation angle.

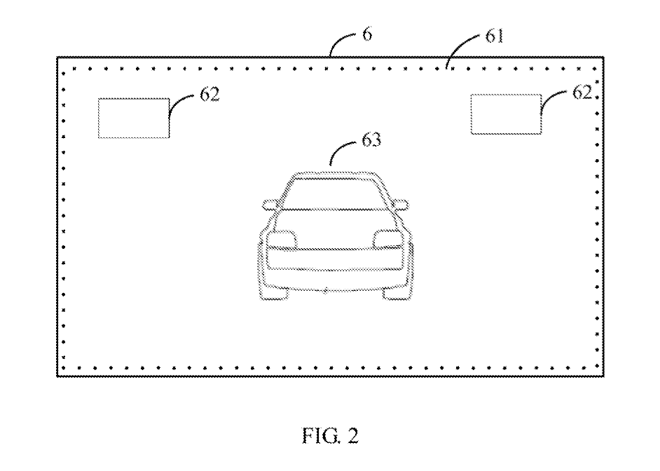

FIG. 2 is one example of a game image 61 displayed on the screen 6 shown in FIG. 1. The control system 20 is configured to adjust the game image 61. In one example, the game image 61 includes two static objects 62 and a dynamic object 63. In the exemplary embodiment, the static objects 62 may be indication information, which indicates scores and rank, for example. The dynamic object 63 may be a race car.

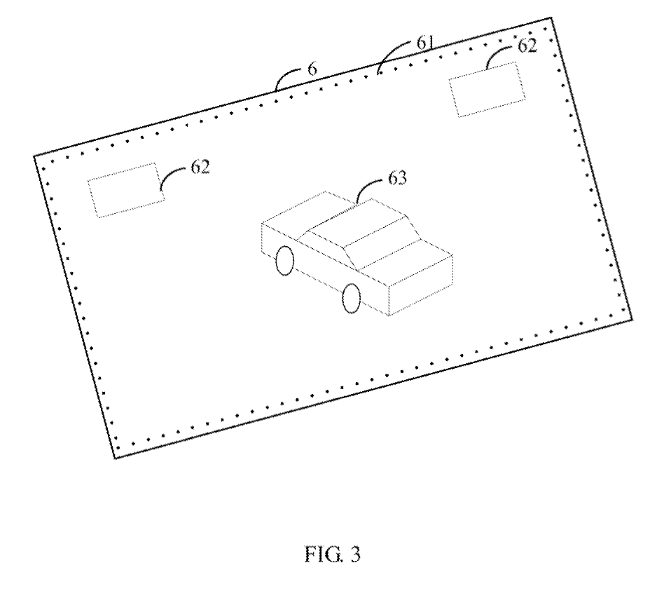

FIG. 3 is one example of the game image 61 shown in FIG. 2 without adjustment during operation. A user can rotate the electronic device 1 counterclockwise relative to the screen 6 to have the dynamic object 63 turn left correspondingly. In this situation, the game image 61 is tilted.

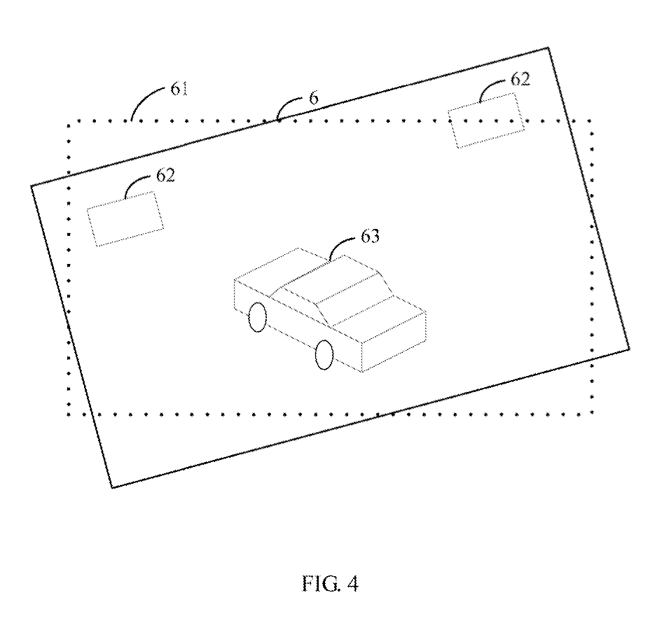

FIG. 4 is one example of the game image 61 shown in FIG. 2 with adjustment during operation. A user can rotate the electronic device 1 counterclockwise relative to the screen 6 to have the dynamic object 63 turn left correspondingly. The acquiring module 201 acquires the rotation angle and the rotation direction (counterclockwise) of the electronic device 1 from the accelerometer 3. The control module 202 rotates the image 61 clockwise by the rotation angle (i.e. the control module 202 reversely rotates the image relative to the rotation direction by the rotation angle).

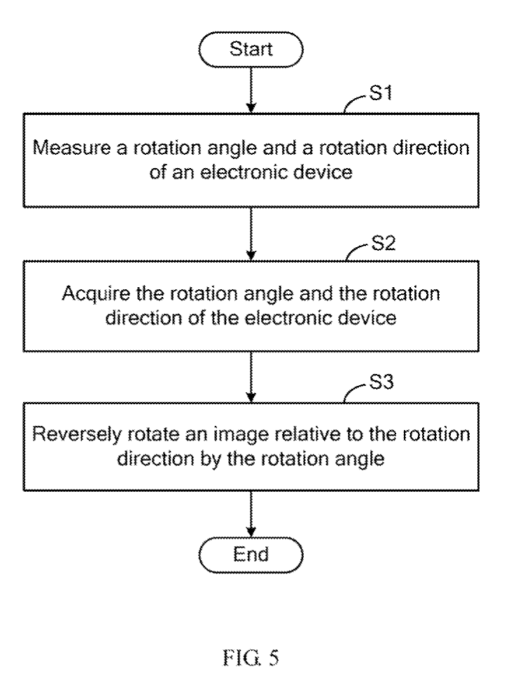

FIG. 5 is a flowchart illustrating one exemplary embodiment of a method for adjusting the image 61 displayed on the screen 6 of the electronic device 1. Depending on the exemplary embodiment, additional blocks may be added, others removed, and the ordering of the blocks may be changed.

In block S1, the accelerometer 3 measures the rotation angle and the rotation direction of the electronic device 1 when the electronic device 1 is rotated.

In block S2, the acquiring module 201 acquires the rotation angle and the rotation direction from the accelerometer 3.

In block S3, the control module 202 reversely rotates the image 61 relative to the rotation direction by the rotation angle.

The present disclosure provides a method for adjusting an image displayed on a screen of an electronic device. The image can be dynamically adjusted for specific application programs.

Although certain inventive exemplary embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for adjusting an image displayed on a screen of an electronic device, the method comprising:
acquiring a rotation angle and a rotation direction of the electronic device when the electronic device is rotated; and
reversely rotating the image relative to the rotation direction by the rotation angle.

2. The method of claim 1, wherein a rotation axis of the rotation direction is perpendicular to the screen.

3. The method of claim 1, wherein the electronic device comprises an accelerometer, the method further comprising:
measuring the rotation angle and the rotation direction of the electronic device using the accelerometer when the electronic device is rotated.

4. An electronic device, comprising:
a storage system;
at least one processor;
a screen configured to display an image;
one or more programs stored in the storage system and being executable by the at least one processor, the one or more programs comprising:
an acquiring module configured to acquire a rotation angle and a rotation direction of the electronic device when the electronic device is rotated; and
a control module configured to reversely rotate the image relative to the rotation direction by the rotation angle.

5. The electronic device of claim 4, wherein a rotation axis of the rotation direction is perpendicular to the screen.

6. The electronic device of claim 4, further comprises an accelerometer configured to measure the rotation angle and the rotation direction of the electronic device when the electronic device is rotated.

7. A storage medium having stored thereon instructions that, when executed by a processor, causing the processor to perform a method for adjusting an image displayed on a screen of an electronic device, wherein the method comprises:
acquire a rotation angle and a rotation direction of the electronic device when the electronic device is rotated; and
reversely rotate the image relative to the rotation direction by the rotation angle.

8. The storage medium of claim 7, wherein a rotation axis of the rotation direction is perpendicular to the screen.

9. The storage medium of claim 7, wherein the electronic device comprises an accelerometer, the method further comprises:
measure the rotation angle and the rotation direction of the electronic device using the accelerometer when the electronic device is rotated.
